(19) United States
(12) Patent Application Publication
(10) Pub. No.: US 2009/0116413 A1
(43) Pub. Date: May 7, 2009

(54) System and method for automatic topology determination in a hierarchical-temporal network

(76) Inventor: Dileep George, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/288,185

(22) Filed: Oct. 17, 2008

Related U.S. Application Data
(60) Provisional application No. 60/981,043, filed on Oct. 18, 2007.

(51) Int. Cl. H04L 12/28

(52) U.S. Cl. 370/256

(57) ABSTRACT

A system and method for automatically analyzing data streams in a hierarchical and temporal network to identify node positions and the network topology in order to generate a hierarchical model of the temporal or spatial data. The system and method receives data streams, identifies a correlation between the data streams, partitions/clusters the data streams based upon the identified correlation and forms a current level of a hierarchical temporal network by having each cluster of data streams be an input to a hierarchical temporal network node. After training the nodes, each of the nodes creates a new data stream and these data streams are correlated and partitioned/clustered and are input into a node at a next level. The process can repeat until a desired portion of the network topology is determined.

### RELATED APPLICATION

The invention relates to and claims priority to U.S. Provisional application 60/981,043 filed on Oct. 18, 2007 which is incorporated by reference herein in its entirety.

### FIELD OF THE INVENTION

The invention relates to hierarchical-temporal networks, such as hierarchical temporal memory (HTM) networks, and more particularly to creating a network topology for hierarchical temporal networks.

### BACKGROUND OF THE INVENTION

Generally, a “machine” is a system or device that performs or assists in the performance of at least one task. Completing a task often requires the machine to collect, process, and/or output information, possibly in the form of work. For example, a vehicle may have a machine (e.g., a computer) that is designed to continuously collect data from a particular part of the vehicle and responsively notify the driver in case of detected adverse vehicle or driving conditions. However, such a machine is not “intelligent” in that it is designed to operate according to a strict set of rules and instructions predefined in the machine. In other words, a non-intelligent machine is designed to operate deterministically; should, for example, the machine receive an input that is outside the set of inputs it is designed to recognize, the machine is likely to, if at all, generate an output or perform work in a manner that is not helpfully responsive to the novel input.

In an attempt to greatly expand the range of tasks performable by machines, designers have endeavored to build machines that are “intelligent,” i.e., more human- or brain-like in the way they operate and perform tasks, regardless of whether the results of the tasks are tangible. This objective of designing and building intelligent machines necessarily requires that such machines be able to “learn” and, in some cases, is predicated on a believed structure and operation of the human brain. “Machine learning” refers to the ability of a machine to autonomously infer and continuously self-improve through experience, analytical observation, and/or other means.

Machine learning has generally been thought of and attempted to be implemented in one of two contexts: artificial intelligence and neural networks. Artificial intelligence, at least conventionally, is not concerned with the workings of the human brain and is instead dependent on algorithmic solutions (e.g., a computer program) to replicate particular human acts and/or behaviors. A machine designed according to conventional artificial intelligence principles may be, for example, one that through programming is able to consider all possible moves and effects thereof in a game of chess between itself and a human.

Neural networks attempt to mimic certain human brain behavior by using individual processing elements that are interconnected by adjustable connections. The individual processing elements in a neural network are intended to represent neurons in the human brain, and the connections in the neural network are intended to represent synapses between the neurons. Each individual processing element has a transfer function, typically non-linear, that generates an output value based on the input values applied to the individual processing element. Initially, a neural network is “trained” with a known set of inputs and associated outputs. Such training builds and associates strengths with connections between the individual processing elements of the neural network. Once trained, a neural network presented with a novel input set may generate an appropriate output based on the connection characteristics of the neural network.

Some systems have multiple processing elements whose execution needs to be coordinated and scheduled to ensure data dependency requirements are satisfied. Conventional solutions to this scheduling problem utilize a central coordinator that schedules each processing element to ensure that data dependency requirements are met, or a Bulk Synchronous Parallel execution model that requires global synchronization.

A solution is a hierarchical-temporal memory and network. In embodiments of the present invention, learning causes and associating novel input with learned causes are achieved using what may be referred to as a “hierarchical temporal memory” (HTM). An HTM is a hierarchical network of interconnected nodes that individually and collectively (i) learn, over space and time, one or more causes of sensed input data and (ii) determine, dependent on learned causes, likely causes of novel sensed input data. HTMs are further described in U.S. patent application Ser. No. 11/351,437 filed on Feb. 10, 2006, U.S. patent application Ser. No. 11/622,458 filed on Jan. 11, 2007, U.S. patent application Ser. No. 11/622,447 filed on Jan. 11, 2007, U.S. patent application Ser. No. 11/622,448 filed on Jan. 11, 2007, U.S. patent application Ser. No. 11/622,457 filed on Jan. 11, 2007, U.S. patent application Ser. No. 11/622,454 filed on Jan. 11, 2007, U.S. patent application Ser. No. 11/622,456 filed on Jan. 11, 2007, and U.S. patent application Ser. No. 11/622,455 filed on Jan. 11, 2007 which are all incorporated by reference herein in their entirety.

In conventional HTMs the topology of the network is created manually and requires significant detailed knowledge of the data and problem addressed by the network.

### SUMMARY OF THE INVENTION

The invention is a system and method for automatically analyzing data streams in a hierarchical and temporal network to identify node positions and the network topology in order to generate a hierarchical model of the temporal and/or spatial data. The invention receives data streams, identifies a correlation between the data streams, partitions/clusters the data streams based upon the identified correlation and forms a current level of a hierarchical temporal network by having each cluster of data streams be an input to a hierarchical temporal network node. After training the nodes, each of the nodes creates a new data stream and these data streams are correlated and partitioned/clustered and are input into a node at another level. The process can repeat until a desired portion of the network topology is determined.

The features and advantages described in the specification are not all inclusive and, in particular, many additional features and advantages will be apparent to one of ordinary skill in the art in view of the application. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1A illustrates some potential source of inputs to an HTM network including object/causes in accordance with one embodiment of the present invention.

FIG. 1B is an example of an HTM network in accordance with one embodiment of the present invention.

FIG. 1C is an illustration of a topology unit 150 in accordance with one embodiment of the present invention.

FIG. 2 is a flow chart of the automatic topology determination in a hierarchical-temporal network in accordance with one embodiment of the present invention.

FIG. 3 is an example of the operation of the present invention in which nine data streams are analyzed.

FIG. 4 is an example of a correlation matrix in accordance with one embodiment of the present invention.

FIG. 5 is an example of partitioned/clustered data streams in accordance with one embodiment of the present invention.

FIG. 6 is an example of the positioning of hierarchical-temporal nodes in accordance with one embodiment of the present invention.

FIG. 7 is an example showing new node data streams in accordance with one embodiment of the present invention.

FIG. 8 is an example of a correlation matrix for the new node data streams in accordance with one embodiment of the present invention.

FIG. 9 is an example of partitioned/clustered node data streams in accordance with one embodiment of the present invention.

FIG. 10 is an example of partitioned/clustered node data streams and the positioning of additional hierarchical-temporal nodes in accordance with one embodiment of the present invention.

FIG. 11 is an example of partitioned/clustered node data streams and the positioning of additional hierarchical-temporal nodes in accordance with one embodiment of the present invention.

FIG. 12 is a flow chart of an automatic topology determination process in a hierarchical-temporal network using both spatial and temporal correlation of data streams in accordance with one embodiment of the present invention.

FIGS. 13-16 illustrate an example of the operation of the present invention in which eight data streams are analyzed and nodes are identified based upon both spatial and temporal correlation of data streams in accordance with one embodiment of the present invention.

FIG. 17 is a graph illustrating a typical decrease in temporal mutual information as the time (d) increases

### DETAILED DESCRIPTION OF THE INVENTION

A preferred embodiment of the present invention is now described with reference to the figures where like reference numbers indicate identical or functionally similar elements. Also in the figures, the left most digit(s) of each reference number correspond to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

Humans understand and perceive the world in which they live as a collection—or more specifically, a hierarchy—of objects. An “object” is at least partially defined as having some persistent structure over space and/or time. For example, an object may be a car, a person, a building, an idea, a word, a song, or information flowing in a network.

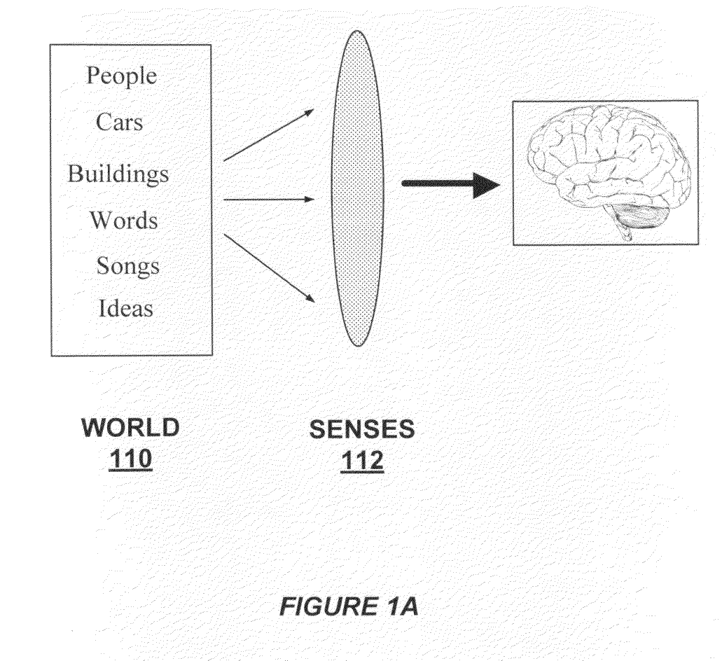

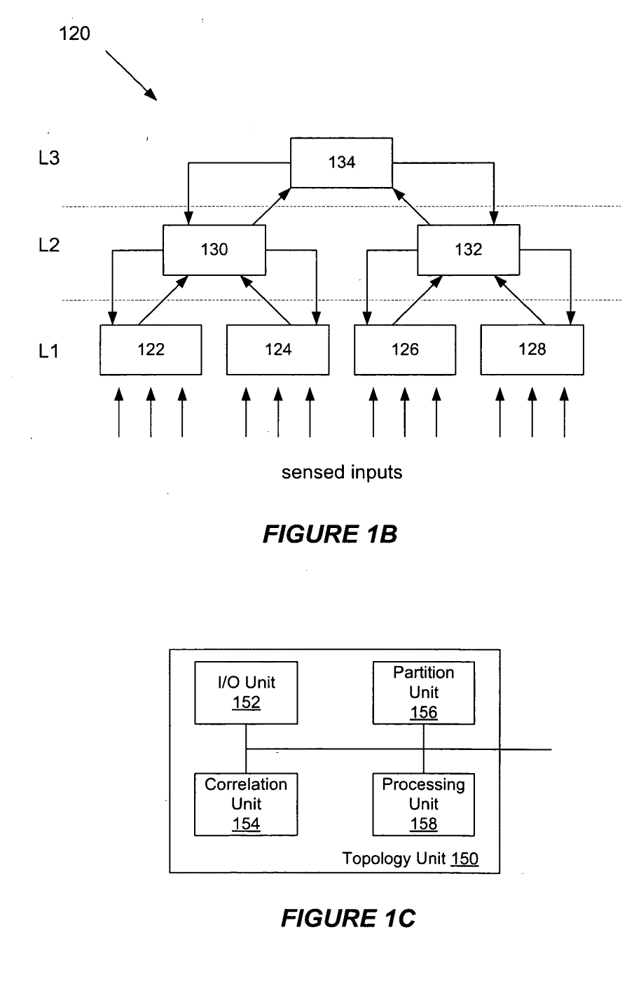

Moreover, referring to FIG. 1A, an object in the world 110 may also be referred to as a “cause” in that the object causes particular data to be sensed, via senses 112, by a human 114. For example, the smell (sensed input data) of a rose (object/cause) results in the recognition/perception of the rose. In another example, the image (sensed input data) of a dog (object/cause) falling upon a human eye results in the recognition/perception of the dog. Even as sensed input data caused by an object change over space and time, humans want to stably perceive the object because the cause of the changing sensed input data, i.e., the object itself, is unchanging. For example, the image (sensed input data) of a dog (object/cause) falling upon the human eye may change with changing light conditions and/or as the human moves; yet, however, the human is able to form and maintain a stable perception of the dog.

In embodiments of the present invention, learning causes and associating novel input with learned causes are achieved using what may be referred to as a “hierarchical temporal memory” (HTM). An HTM is a hierarchical network of interconnected nodes that individually and collectively (i) learn, over space and time, one or more causes of sensed input data and (ii) determine, dependent on learned causes, likely causes of novel sensed input data. HTMs, in accordance with one or more embodiments of the present invention, are further described in the patent applications referenced and incorporated by reference above.

An HTM has several levels of nodes. For example, as shown in FIG. 1B, HTM 120 has three levels L1, L2, L3, with level L1 being the lowest level, level L3 being the highest level, and level L2 being between levels L1 and L3. Level L1 has nodes 122, 124, 126, 128; level L2 has nodes 130, 132, and level L3 has node 134. The nodes 122, 124, 126, 128, 130, 132, 134 are hierarchically connected in a tree-like structure such that each node may have several children nodes (i.e., nodes connected at a lower level) and one parent node (i.e., node connected at a higher level). Each node 122, 124, 126, 128, 130, 132, 134 may have or be associated with a capacity to store and process information. For example, each node 122, 124, 126, 128, 130, 132, 134 may store sensed input data (e.g., sequences of patterns) associated with particular causes. Further, each node 122, 124, 126, 128, 130, 132, 134 may be arranged to (i) propagate information “forward” (i.e., “up” an HTM hierarchy) to any connected parent node and/or (ii) propagate information “back” (i.e., “down an HTM hierarchy) to any connected children nodes.

Inputs to the HTM 120 from, for example, a sensory system, are supplied to the level L1 nodes 122, 124, 126, 128. A sensory system through which sensed input data is supplied to level L1 nodes 122, 124, 126, 128 may relate to commonly thought-of human senses (e.g., touch, sight, sound) or other human or non-human senses. For example, optical sensors can be used to supply the inputs to the level L1 nodes.

The range of sensed input data that each of the level L1 nodes 122, 124, 126, 128 is arranged to receive is a subset of an entire input space. For example, if an 8×8 image represents an entire input space, each level L1 node 122, 124, 126, 128 may receive sensed input data from a particular 4×4 section of the 8×8 image. Each level L2 node 130, 132, by being apparent of more than one level L1 node 122, 124, 126, 128, covers more of the entire input space than does each individual level L1 node 122, 124, 126, 128. It follows that in FIG. 1B, the level L3 node 134 covers the entire input space by receiving, in some form, the sensed input data received by all of the level L1 nodes 122, 124, 126, 128. Moreover, in one or more embodiments of the present invention, the ranges of sensed input data received by two or more nodes 122, 124, 126, 128, 130, 132, 134 may overlap.

While HTM 120 in FIG. 1B is shown and described as having three levels, an HTM in accordance with one or more embodiments of the present invention may have any number of levels. Moreover, the hierarchical structure of an HTM may be different than that shown in FIG. 1B. For example, an HTM may be structured such that one or more parent nodes have any number of children nodes as opposed to two children nodes like that shown in FIG. 1B. Further, in one or more embodiments of the present invention, an HTM may be structured such that a parent node in one level of the HTM has a different number of children nodes than a parent node in the same or another level of the HTM. Further, in one or more embodiments of the present invention, an HTM may be structured such that a parent node receives input from children nodes in multiple levels of the HTM. In general, those skilled in the art will note that there are various and numerous ways to structure an HTM other than as shown in FIG. 1B.

Any entity that uses or is otherwise dependent on an HTM as, for example, described above with reference to FIG. 1B, may be referred to as an “HTM-based” system. Thus, for example, an HTM-based system may be a machine that uses an HTM, either implemented in hardware or software, in performing or assisting in the performance of a task. An HTM-based system or network is an example of a hierarchical-temporal network.

FIG. 1C is an illustration of a topology unit 150 in accordance with one embodiment of the present invention. In one embodiment, the topology unit 150 includes an input/output (I/O) unit 152, a correlation unit 154, a partition unit 156 and a processing unit 158. As described above, the topology unit can be part of a general purpose computer or part of an HTM computing system/network and can be implemented in software, computer readable media, firmware etc.

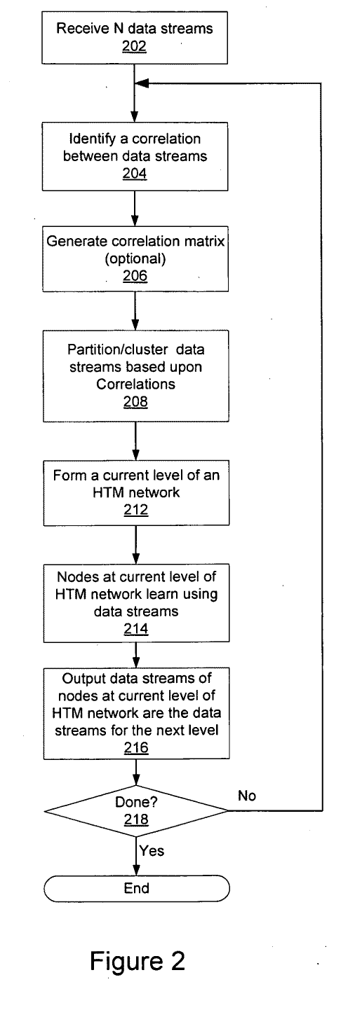

FIG. 2 is a flow chart of the automatic topology determination in a hierarchical-temporal network in accordance with one embodiment of the present invention (in one embodiment this is referred to as the spatial topography algorithm). The operation of various embodiments of the invention will be described with reference to FIGS. 2-17. The topology unit 150 receives 202 N data streams (where N can be any number) at the I/O unit 152. The data streams represent data either (1) data received over time from sensors or other devices that detect/sense objects (either actual or training data) or (2) data received from HTM nodes (either actual or training data). In some embodiments, multiple HTM networks can be combined and data streams can be from nodes in a different HTM network.

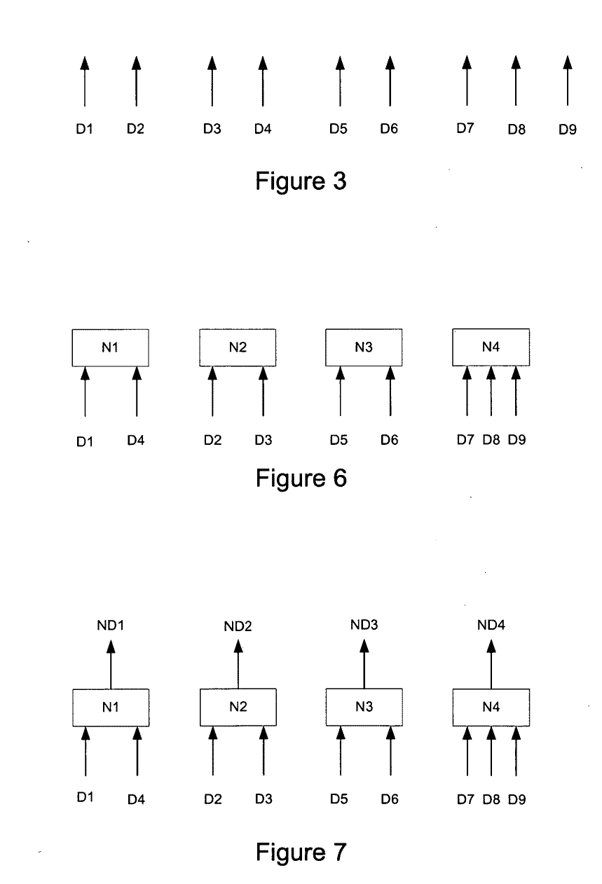

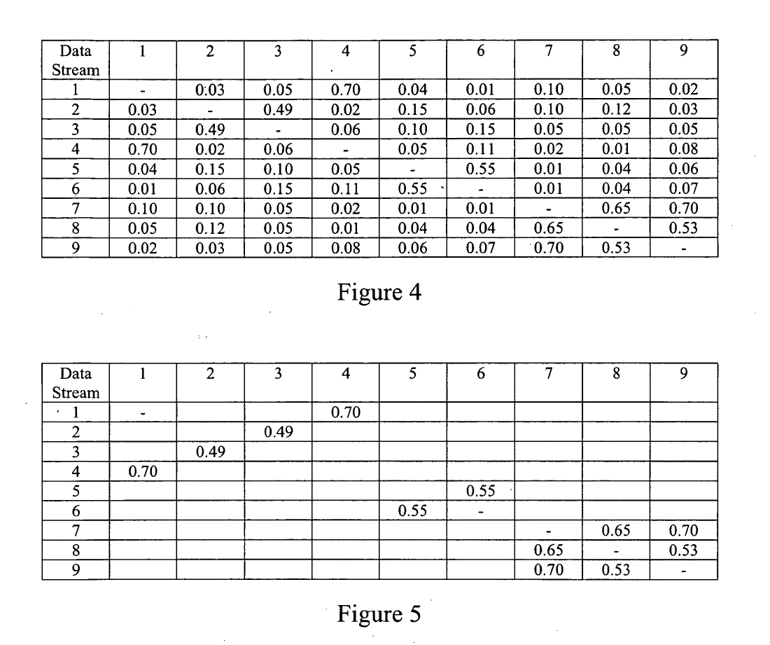

FIG. 3 is an example of the operation of the present invention in which nine data streams are analyzed. In the example illustrated in FIG. 3 the topology unit 150 receives 202 nine data streams (D1-D9). The correlation unit 154 then identifies 204 a correlation between the data streams. More generally the correlation unit 154 identifies 204 the mutual information between the data streams. Various conventional correlation methodologies can be used to determine the correlation between the data streams. Examples of such correlation methods include mutual information, linear correlation etc. Mutual Information refers to the reduction in uncertainty (entropy) of one data stream given another. In one embodiment the mutual information helps identify the spatial relationship between the data, e.g., which data should be input into various nodes. The correlation unit identifies 204 the correlation (or other measure of mutual information) between the data streams and this information can optionally be organized 208 in a correlation matrix. FIG. 4 is an example of a correlation matrix in accordance with one embodiment of the present invention. The correlation matrix of FIG. 4 is merely exemplary and is not intended to limit the types of mutual information that can be used by the present invention. In FIG. 4 the correlation value M(i,j) is equal to the intersection of the data streams. For example the correlation of data stream 1 (D1) and data stream 4 (D4) is 0.70.

The correlation information is received by the partition unit 156 that forms partitions (or clusters) based upon the correlation information. Various clustering methodologies can be used to determine the partitions/clusters. Examples of such clustering methodologies include Agglomorative Hierarchical Clustering, spectral graph partitioning etc. The partition unit 156 partitions/clusters 208 the data streams based upon the correlation information. FIG. 5 is an example of partitioned/clustered data streams in accordance with one embodiment of the present invention. In FIG. 5 the correlation information is shown for those data streams that are clustered together. In this example, data streams D1 and D4 form a cluster, data streams D2 and D3 form a second cluster, data streams D5 and D6 form a third cluster and data streams D7, D8 and D9 form a fourth cluster.

The topology unit 150 then forms 212 a current level of an HTM network (or other hierarchical-temporal network) by having each cluster of data streams be inputs to an HTM node. FIG. 6 is an example of the positioning of hierarchical-temporal nodes in accordance with one embodiment of the present invention. In this example, node N1 corresponds to the first cluster and has data streams D1 and D4 as its inputs. Node N2 has data streams D2 and D3 as its inputs. Node N3 has data streams D5 and D6 as its inputs. Node N4 has data streams D7, D8 and D9 as its inputs.

Each of the HTM nodes then “learns” 214 using the data from its input data streams. As described above, the data streams can represent training data or actual data (or a combination). Examples of how HTM nodes can learn are described in the US patent applications referenced above. It is preferred, although not required, to wait until the nodes have initially completed some learning before capturing and using the output from the nodes. Ideally, the nodes will have observed their inputs for a long enough time to get stable statistics. FIG. 7 is an example showing new node data streams in accordance with one embodiment of the present invention. In this example, each node outputs node data. Nodes N1-N4 output node data ND1-ND4 respectively.

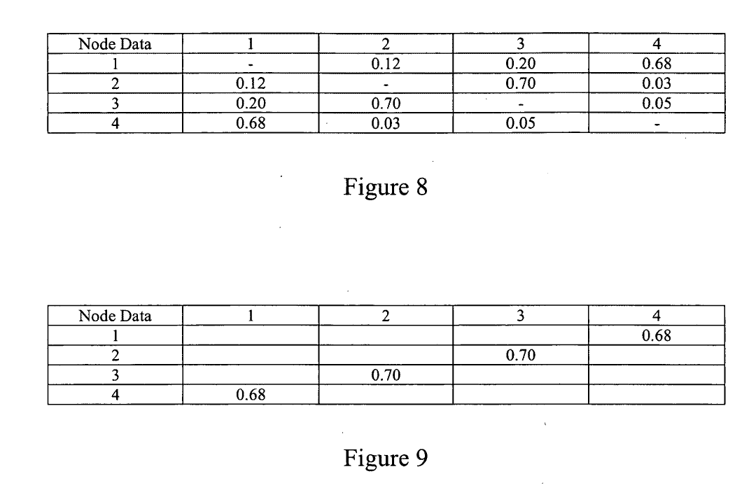

If the topology identification is not complete 218 then the process continues with the outputs from the previous level of nodes, i.e., node data D1-D4, used as the N data streams to identify a new level in the hierarchical-temporal network topology, e.g., an HTM topology. In this example, four data streams (D1-D4) are received and the correlation unit 154 identifies 204 a correlation between the data streams in a manner similar to that described above. FIG. 8 is an example of a correlation matrix 206 for the new node data streams in accordance with one embodiment of the present invention. In FIG. 8 the correlation value M(i,j) between two data streams (data stream i and data stream j) is equal to the intersection of the data streams. For example the correlation of data stream 1 (ND1) and data stream 4 (ND4) is 0.68.

The correlation information is received by the partition unit 156 that forms partitions (or clusters) based upon the correlation information, as described above. The partition unit 156 partitions/clusters 208 the data streams based upon the correlation information. FIG. 9 is an example of partitioned/clustered node data streams in accordance with one embodiment of the present invention. In FIG. 9 the correlation information is shown for those data streams who are clustered together. In this example, data streams ND1 and ND4 form a cluster, and data streams ND2 and ND3 form a second cluster.

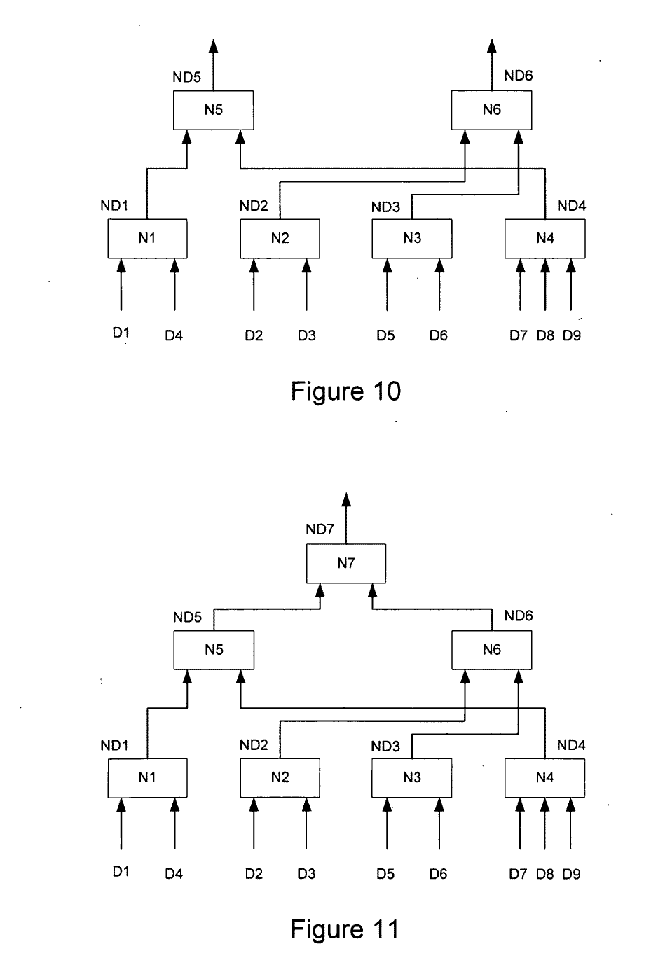

The topology unit 150 then forms 212 a current level of an HTM network (or other hierarchical-temporal network) by having each cluster of data streams be inputs to an HTM node. FIG. 10 is an example of partitioned/clustered node data streams and the positioning of additional hierarchical-temporal nodes in accordance with one embodiment of the present invention. In this example, node N5 corresponds to one cluster and has data streams ND11 and ND4 as its inputs. Node N6 has data streams ND2 and ND3 as its inputs. As shown in example illustrated in FIG. 10, each node outputs node data. Node N5 outputs node data ND5 and node N6 outputs node data ND6.

If the topology identification is not complete 218 then the process continues with the outputs from the previous level of nodes, i.e., node data D5-D6, used as the N data streams to identify a new level in the hierarchical-temporal network topology, e.g., an HTM topology. In this example, two data streams (D1-D4) are received and the correlation unit 154 identifies 204 a correlation between the data streams in a manner similar to that described above. Then a correlation matrix can optionally be generated 206 in the manner described above. The partition unit 156 then partitions 208 clusters the data streams based upon the correlations and the next level of the HTM network is formed 212 by having a node receive the clustered data streams. FIG. 11 is an example of partitioned/clustered node data streams and the positioning of additional hierarchical-temporal nodes in accordance with one embodiment of the present invention. In FIG. 11 node N7 receives the clustered data streams, i.e., data streams ND5 and ND6. The new node then learns 214 in the manner described above and the output of the node at the new level is a new data stream. In this example the new data stream is ND7. In this example the topology identification is now complete 218 and the process ends.

The example described herein was used to help understand the invention but is not intended to limit the scope of the invention. For example, in other embodiments the topology need not terminate with a single node, some data streams may not be clustered with any other data streams, the correlation matrix can include data streams from nodes at two or more levels—for example data stream D9 can be part of the correlation matrix that includes data streams ND1-ND4. In this case the data stream can be part correlated with data streams D1-D8, ND1-ND4 or both.

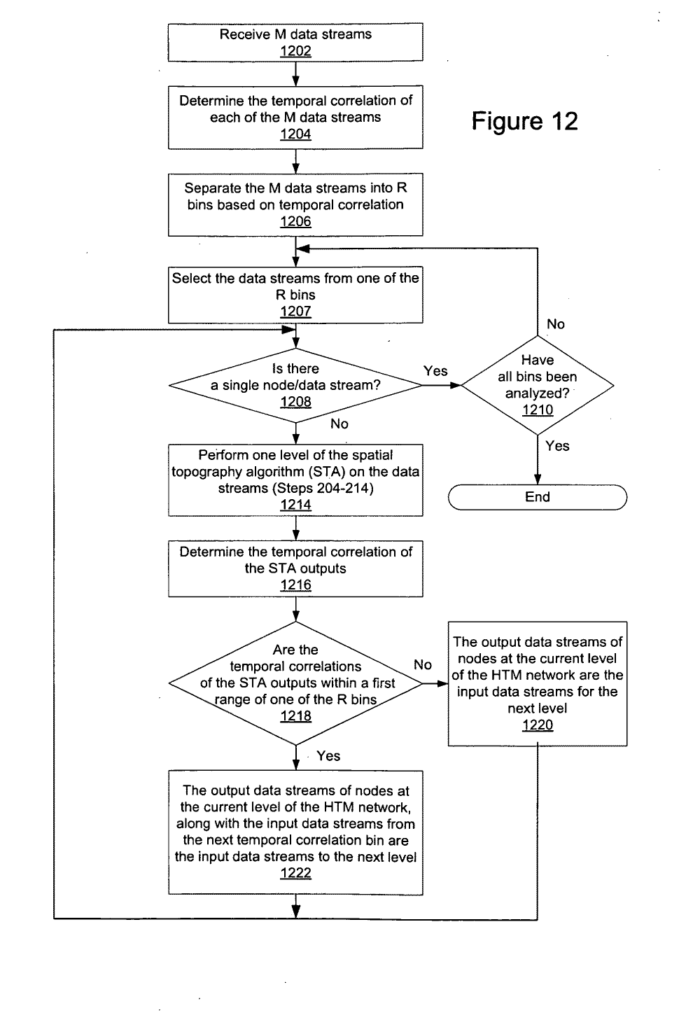

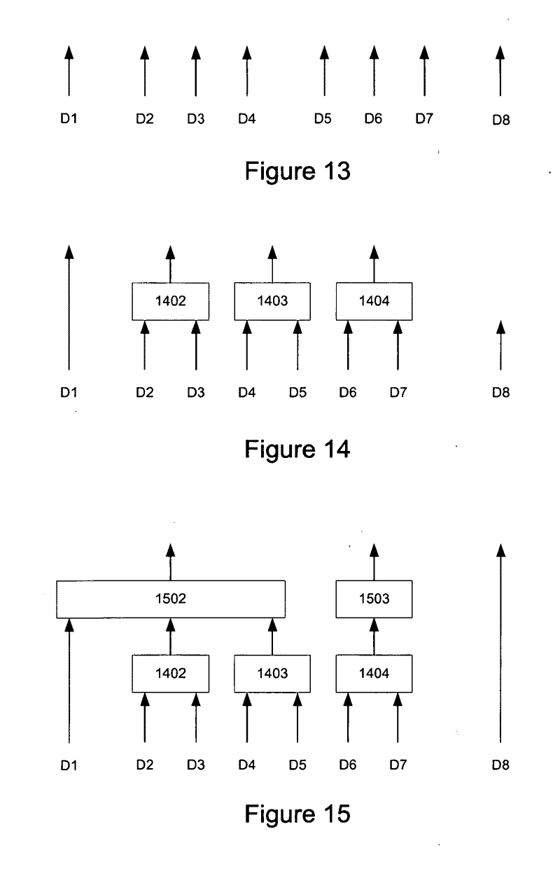

In another example, automatic topology determination can be based upon both spatial and temporal correlation factors. FIG. 12 is a flow chart of the automatic topology determination in a hierarchical-temporal network using both spatial and temporal correlation of data streams in accordance with one embodiment of the present invention. FIG. 12 is described herein with reference to FIGS. 13-17.

FIGS. 13-16 illustrate an example of the operation of the present invention in which eight data streams are analyzed and nodes are identified based upon both spatial and temporal correlation of data streams in accordance with one embodiment of the present invention. With reference to FIG. 12, the topology unit 150 receives 1202 M data streams (where M can be any number) at the I/O unit 152. The data streams represent data either (1) data received over time from sensors or other devices that detect/sense objects (either actual or training data) or (2) data received from HTM nodes (either actual or training data). In some embodiments, multiple HTM networks can be combined and data streams can be from nodes in a different HTM network. The correlation unit 154 of the topology unit 150 determines 1204 the temporal correlation of each of the M data streams.

The temporal correlation can be determined 1204 in a variety of ways. One example is based upon the temporal mutual information of the data stream which is the mutual information between a data stream and a delayed version of itself. For example, if x[n] represents a data sequence, the temporal mutual information measures how much the uncertainty about x[n] is reduced by knowing a value of the data stream at a previous time d, i.e., x[n−d]. Mutual information between two streams Y and Z is defined as the H(Y)−H(Y|Z) where H denotes the entropy of the stream. It is common that as the delay (d) increases the temporal mutual information, and therefore the temporal correlation, decreases. FIG. 17 is a graph illustrating a typical decrease in temporal mutual information as the time (d) increases. In one example, the value of the temporal correlation can be based upon the value of the delay (d) that results in a particular reduction in the value of the temporal mutual information, e.g., the time (d) to reach a 90% reduction from the maximum. In FIG. 17, the horizontal axis represents time and the vertical axis represents the temporal mutual information such as the automatic uncertainty coefficient/automatic correlation coefficient. The temporal mutual information is plotted after normalizing it with the maximum value that occurs when the time delay is zero. When the time delay (d) is zero the temporal mutual information is maximum since that value of data stream is known. As the delay (d) increases the temporal correlation decreases.

Any measure that indicates the predictability of a data stream can be used in place of the temporal correlation described above. For example, in place of measuring mutual information, linear correlation can be measured with the delayed streams. The temporal correlation of a data stream can be, for example, defined in terms of its auto-correlation function. Such measurements can be normalized in different ways while still maintaining monotonicity with respect to temporal predictability.

After the correlation unit 154 determines 1204 the temporal correlation of each of the M data streams, the partition unit 156 separates 1206 the M data streams into R separate bins based upon the temporal correlation value (where R is the number of bins). With reference to the example illustrated in FIG. 13, eight data streams are represented as D1-D8. Each has a determined a temporal correlation value. In this example the temporal correlation values are: D1: 12; D2: 4; D3: 6: D4: 5; D5: 5; D6: 7; D7: 6; D8: 22. In this example there are three bins into which the data streams are separated. Bin 1 includes those data streams having values near 5, e.g., between 1 and 10, Bin 2 includes those data streams having values near 15, e.g., between 11 and 20; and Bin 3 includes those data streams having values near 25, e.g., between 21 and 30. In will be apparent that any number of bins can be used and the value(s) included in each bin can be different than that set forth in this example. Based upon this, the eight data streams are separated 1206 into three bins. Bin 1 includes data streams D2-D7, Bin 2 includes data stream D1, and Bin 3 includes data stream D8.

The partition unit 156 then selects 1207 the data streams from one of the R bins. In one embodiment the bin having the lowest temporal correlation value is selected. In another embodiment, the bin with the highest number of data streams is selected. In this example the bin having the lowest temporal correlation value is selected, that is, Bin 1. The partition unit 156 determines 1208 whether only a single node or data stream has been selected. In this example, Bin 1 has six data streams so the partition unit 156 continues by performing 1214 one level of the spatial topography algorithm on the data streams. This corresponds to steps 204-214 in FIG. 2. The operation of the spatial topography algorithm is described above. FIG. 14 is an illustration of the result of steps 204-214 being applied to data streams D2-D7. In particular, three nodes 1402, 1403, 1404 are identified, each having an output data stream.

The correlation unit 154 then determines 1216 the temporal correlation of each of the output streams from the three nodes 1402-1404 using the technique described above, for example. In this example, the temporal correlation values of the three nodes are: node 1402: 13; node 1403: 15; node 1404: 12.

The partition unit 156 then determines 1218 whether the temporal correlations of node data streams (corresponding to nodes 1402-1404) based upon the spatial topography algorithm are within a range of one of the unanalyzed bins. In this situation the values of the 3 nodes are each within the range of Bin 2. In alternate embodiments, the range of the bins can be adjusted prior to determining whether any of the new node data streams are within the range. In another embodiment the correlation values of the three node data streams can be combined, e.g., averaged, and this combined value can determine which bin the three node data streams will be a part of. In the example above, all three node data streams are within the range of Bin 2, however, this is not required and one or more may be part of a separate Bin.

In this example, the three node data streams all fall within the range of Bin 2. Therefore the partition unit 156 assigns 1222 the output data streams of the nodes at the current level of the HTM network (the node data streams) along with the input data stream from the next temporal correlation bin, i.e., the bin within which the correlation values of the node data streams reside, as input data streams to the next level. In this example, the node data streams from nodes 1402-1404 along with the data stream from Bin 2, i.e., data stream D1, are inputs to the next level.

The process continues with the partition unit 156 determining 1208 whether only a single node or data stream has been selected. In this example, the combination of Bin 2 (data stream D1) and the node data streams from nodes 1402-1404 are four data streams so the partition unit 156 continues by performing 1214 one level of the spatial topography algorithm on the data streams. As described above, this corresponds to steps 204-214 in FIG. 2. FIG. 15 is an illustration of the result of steps 204-214 being applied to data stream D1 and the node data streams from 1402-1404. In particular, two nodes 1502 and 1503 are identified, each having an output data stream.

The correlation unit 154 then determines 1216 the temporal correlation of each of the output streams from the two nodes 1502-1503. In this example, the temporal correlation values of the three nodes are: node 1502: 15; node 1503: 17.

The partition unit 156 then determines 1218 whether the temporal correlations of node data streams (corresponding to nodes 1502-1503) based upon the spatial topography algorithm are within a range of one of the unanalyzed bins. In this situation the values of the 2 nodes are not within the range of any unanalyzed bin, i.e., it is outside the range of unanalyzed Bin 3 which has the range of 21-30. As described above, in alternate embodiments, the range of the bins can be adjusted prior to determining whether any of the new node data streams are within the range.

Since the temporal correlation values of the node data streams corresponding to nodes 1502-1503 are not within the range of an unanalyzed bin, the partition unit assigns 1220 the output data streams of the nodes (1502-1503) at the current level of the HTM network (the node data streams) as input data streams to the next level. In this example, the node data streams from nodes 1502-1503 are inputs to the next level.

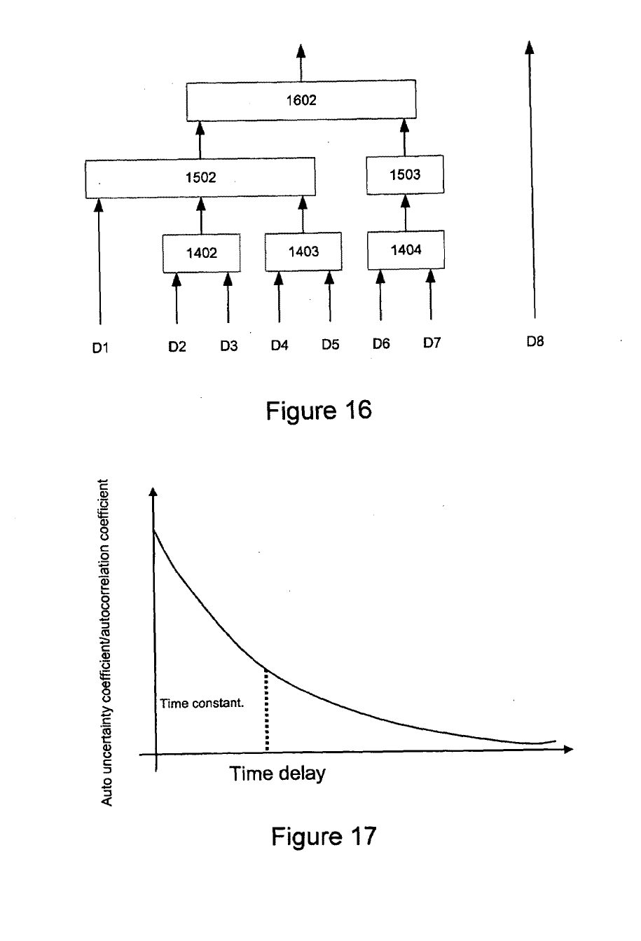

The process continues with the partition unit 156 determining 1208 whether only a single node or data stream has been selected. In this example, two node data streams (output from nodes 1502 and 1503) are inputs. The partition unit 156 then continues by performing 1214 one level of the spatial topography algorithm on the data streams. As described above, this corresponds to steps 204-214 in FIG. 2. FIG. 16 is an illustration of the result of steps 204-214 being applied to the node data streams from 1502-1503. In particular, a single node, node 1602 is identified.

The correlation unit 154 then determines 1216 the temporal correlation of the output stream of node 1602. In this example, the temporal correlation values of node data stream output from node 1602 is 14.

The partition unit 156 then determines 1218 whether the temporal correlations of node data streams (corresponding to nodes 1502-1503) based upon the spatial topography algorithm are within a range of one of the unanalyzed bins. In this situation the temporal correlation values of node data stream of node 1602 is not within the range of any unanalyzed bin, i.e., it is outside the range of unanalyzed Bin 3 which has the range of 21-30. As described above, in alternate embodiments, the range of the bins can be adjusted prior to determining whether any of the new node data streams are within the range.

Since the temporal correlation values of the node data stream corresponding to node 1602 is are not within the range of an unanalyzed bin, the partition unit assigns 1220 the output data stream of node 1602 at the current level of the HTM network (the node data stream) as input data streams to the next level. In this example, the node data stream from node 1602 is the input to the next level.

The process continues with the partition unit 156 determining 1208 whether only a single node or data stream has been selected. In this example, only a single node data stream is input (corresponding to node 1602). Accordingly the partition unit determines 1210 whether all bins have been analyzed. In this example, Bin 3 has not been analyzed so the process continues by selecting 1207 the data stream from one of the R bins. The selection here is from one of the unanalyzed bins. In this example Bin 3 is selected which has a single data stream, D8. The partition unit 156 determines 1208 that only a single data stream has been selected and then determines 1210 that all bins have been analyzed so the process is complete.

In other embodiments: (1) it is not necessary to have the clustering to be non-overlapping—this will create topologies where one node can have multiple parents; (2) it is not necessary to have only one node at the top level—it is possible to have hierarchies that have nodes terminating at multiple levels; (3) Prior knowledge about which data streams go together can be incorporated into this method—incorporating prior knowledge can reduce computation time taken to measure the correlations; and (4) the system and method can be extended to involve user interaction at every stage of the process.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

What is claimed is:

1. A method for creating a hierarchical model for temporal data, comprising the steps of:
(a) receiving a plurality of data streams comprising the temporal data;
(b) identifying a mutual information value between pairs of said data streams, said mutual information value representing the mutual information between said pair of data streams;
(c) clustering said data streams into at least two clusters based upon said mutual information;
(d) creating a current level of the hierarchical model based upon said clusters, wherein said current level generates additional data streams; and
(e) repeating steps (b)-(d) for said additional data streams to create different levels of the hierarchical model.

2. The method of claim 1, wherein the hierarchical model represents a hierarchical temporal memory network.

3. The method of claim 1, wherein the step of creating a current level includes the step of creating a node for each cluster.

4. The method of claim 1, wherein said mutual information represents a correlation between pairs of said data streams.

5. The method of claim 1, wherein the data streams can be received from different levels of the hierarchical model.

6. The method of claim 1, wherein said mutual information is based upon at least one of spatial correspondence or temporal correspondence.

7. A system for creating a hierarchical model for temporal data, comprising:
receiving means for receiving a plurality of data streams comprising the temporal data;
mutual information means, configured to receive said plurality of data streams from said receiving means, for identifying a mutual information value between pairs of said data streams, said mutual information value representing the mutual information between said pair of data stream;
clustering means, configured to receive said mutual information values from said mutual information means, for clustering said data streams into at least two clusters based upon said mutual information;
hierarchical model means, configured to receive said clusters from said clustering means, for creating a current level of the hierarchical model based upon said clusters, wherein said current level generates additional data streams that are sent to the receiving means in order to start the process of creating additional levels of the hierarchical model.

8. The system of claim 7, wherein the hierarchical model represents a hierarchical temporal memory network.

9. The system of claim 7, wherein the step of creating a current level includes the step of creating a node for each cluster.

10. The system of claim 7, wherein said mutual information represents a correlation between pairs of said data streams.

11. The system of claim 7, wherein the data streams can be received from different levels of the hierarchical model.

12. The system of claim 7, wherein said mutual information is based upon at least one of spatial correspondence or temporal correspondence.

13. A computer program product embodied on a computer readable medium which when executed performs the method steps of claim 1.
